(19) United States
(12) Patent Application Publication
(10) Pub. No.: US 2009/0042543 A1
(43) Pub. Date: Feb. 12, 2009

(54) Cellular phone

(75) Inventors: Keisuke Nagata, Daito-shi (JP); Miwa Koshijima, Osaka-shi (JP)

Correspondence Address: KRATZ, QUINTOS & HANSON, LLP, 1420 K Street, N.W., Suite 400, WASHINGTON, DC, 20005, US

(73) Assignee: SANYO ELECTRIC CO., LTD., Moriguchi-shi, (JP)

(21) Appl. No.: 11/919,970

(22) PCT Filed: May 18, 2006
(86) PCT No.: PCT/JP2006/309964

§ 371 Date: Nov. 6, 2007

(30) Foreign Application Priority Data
May 20, 2005 (JP) 2005-147647

(51) Int. Cl. H04W 99/00

(52) U.S. Cl. 455/412.2

(57) ABSTRACT

A mobile phone 100 includes a display control unit 152, a setting unit 151, a pictogram detection unit 153, a ringtone determination unit 154, and a speaker driving unit 170. The display control unit 152 has a display unit 110 display an image for receiving an operation of associating a predetermined pictogram code with sound data. The setting unit 151 receives an operation of an input unit 120 by a user, and stores received sound data and pictogram code into a storage unit 160. The pictogram detection unit 153 detects a pictogram code in mail received by a radio unit 140. The ringtone determination unit 154 determines sound data corresponding to the detected pictogram code. The speaker driving unit 170 has a speaker 180 output a sound based on the determined sound data.

### TECHNICAL FIELD

The present invention relates to a mobile phone, and especially relates to a technique of informing a user by a sound and the like when receiving mail that contains a character such as a JIS (Japanese Industrial Standards) letter, symbol, or special character, or a pictogram defined independently by each mobile communication service provider.

### BACKGROUND ART

When receiving an incoming call or mail, a conventional mobile phone can inform a user of the incoming call or mail by outputting a sound (hereafter referred to as a “ringtone”) such as a melody or song which the user likes. Different ringtones can be set for different callers/senders so that the user can specify who made/sent the call/mail (patent document 1).

Also, the user can create mail using pictograms which have been set in the mobile phone beforehand. For example, these pictograms can represent the user's feelings, enabling the user to emphasize the contents of the mail and improve his/her expressiveness.

When receiving mail containing such pictograms, by displaying letters and pictograms of the mail on a display, the user can recognize the contents of the mail and estimate the sender's feelings and the like expressed by the pictograms.

Thus, by creating mail using pictograms, it is possible to easily convey one's feelings and the like to the other. Therefore, many users tend to frequently use pictograms rather than letters.

Patent document 1: Japanese patent application publication No. H10-190779.

### DISCLOSURE OF THE INVENTION

### Problems the Invention is Going to Solve

However, when receiving mail containing a pictogram that indicates, for example, a request for an immediate reply, the mobile phone of the patent document 1 allows the user to know who sent the mail by a ringtone, but the user may not instantly check the contents of the mail because the user does not know what kind of mail he/she has received.

Thus, the mobile phone of the patent document 1 has a problem that the user cannot know what kind of mail he/she has received until displaying the received mail.

The present invention was conceived in view of the above problem, and aims to provide a mobile phone that, when receiving mail, enables a user to estimate what kind of mail he/she has received.

### Means of Solving the Problems

The stated aim can be achieved by a mobile phone that receives mail, including: a storage unit operable to store one or more specific characters and sound data in correspondence with each other; a detection unit operable to detect, when the mail is received, any specific character out of the one or more specific characters in the received mail; and an output control unit operable to output a sound based on the sound data, if the detection unit detects the specific character.

For example, the specific character is a pictogram defined independently by a mobile communication service provider, a character specified by a user from among JIS characters including letters, symbols, and special characters and combinations of these JIS characters, and the like. Note here that a pictogram is composed of a character code predetermined by the mobile communication service provider.

Here, the mail may contain one or more types of specific characters, wherein the storage unit stores sound data corresponding to each type of specific character, the detection unit detects the one or more types of specific characters from a beginning of the mail in sequence, and the output control unit determines, as an output target, sound data corresponding to a type of specific character detected first by the detection unit, and outputs the sound based on the sound data determined as the output target.

### EFFECTS OF THE INVENTION

According to the above structure, in the case where sound data such as a ringtone is stored in correspondence with a meaning expressed by a specific character such as a pictogram, when receiving mail containing the specific character, the sound data corresponding to the specific character is output. This enables the user to estimate the contents of the mail upon reception by hearing the sound, without having to display the mail.

Here, the one or more specific characters may be a plurality of types of specific characters, wherein the detection unit detects the plurality of types of specific characters in the mail and, for each type of specific character, counts a number of times the type of specific character is detected, and the output control unit determines, as an output target, sound data corresponding to a type of specific character having a largest number of times counted by the detection unit, and outputs the sound based on the sound data determined as the output target.

According to the above structure, for example, if different specific characters are contained in received mail, sound data corresponding to a pictogram which is detected a largest number of times is determined to be output. This enables the user to estimate the feelings and the like of the sender from a ringtone that is output based on the pictogram frequently used in the received mail.

Here, the mail may contain one or more types of specific characters, wherein the storage unit stores sound data corresponding to each type of specific character, the detection unit detects the one or more types of specific characters from a beginning of the mail in sequence, and the output control unit determines, as an output target, sound data corresponding to each type of specific character detected by the detection unit, and outputs the sound based on the sound data determined as the output target in an order of the detection by the detection unit.

According to the above structure, for example, if different specific characters are contained in received mail, sound data respectively corresponding to the detected specific characters are output in an order of detection. This enables the user to comprehensively estimate the feelings and the like of the sender expressed by the specific characters contained in the received mail, from ringtones output based on the respective specific characters.

Here, the one or more specific characters may be a plurality of types of specific characters, wherein the storage unit stores a plurality of groups into which the plurality of types of specific characters are sorted, and sound data corresponding to each of the plurality of groups, and the output control unit determines, as an output target, sound data corresponding to a group to which the specific character detected by the detection unit belongs, and outputs the sound based on the sound data determined as the output target.

According to the above structure, for example, if a plurality of pictograms belong to a group for expressing “happy” feelings, the sender has a wide range of choice of pictograms for expressing “happy” feelings. When these pictograms are contained in the received mail, sound data corresponding to the group “happy” is output. This makes it unnecessary to store sound data corresponding to each pictogram in the receiver's mobile phone, with it being possible to reduce an amount of storage.

Here, the mobile phone may further include: a display unit operable to display the specific character; and a selection receiving unit operable to receive a selection of the sound data while the specific character is being displayed by the display unit, wherein the storage unit stores the displayed specific character and the selected sound data in correspondence with each other.

According to the above structure, it is possible to display a specific character and receive a selection of sound data corresponding to the specific character. That is, while viewing a pictogram or the like displayed on a display, the user can associate desired sound data with the pictogram in accordance with a meaning represented by the pictogram. This being so, a ringtone associated with the pictogram by the user himself/herself is output when receiving mail, so that the user can easily estimate what kind of mail he/she has received.

Here, the storage unit may further store an output time period in correspondence with the sound data, wherein the output control unit outputs the sound based on the sound data for the output time period corresponding to the sound data, based on the sound data and the output time period stored in the storage unit.

According to the above structure, for example, the user sets an output time period of sound data corresponding to a pictogram that has a particularly high need of alert, to be longer than an output time period of other sound data. As a result, when mail is received, the reception of the mail containing that pictogram is informed with an emphasis.

Here, the mail may be composed of mail header data and mail body data, wherein the detection unit detects the specific character in the mail header data, when the mail header data is received, and the output control unit determines, when the mail header data is received, the sound data corresponding to the detected specific character as an output target, and outputs the sound based on the sound data determined as the output target.

According to the above structure, since the mail header part is often used as a title that indicates a main subject which the sender wants to convey to the receiver, when receiving the mail header part, the user can estimate the outline of the mail based on a ringtone corresponding to a pictogram that is contained in the mail header part.

Here, the detection unit may further detect the specific character in the mail body data, when the mail body data is received, wherein the output control unit further determines, when the mail body data is received, the sound data corresponding to the detected specific character as an output target, and outputs the sound based on the sound data determined as the output target.

According to the above structure, for example, even in the case of short mail that has no mail header part or mail that does not contain any pictogram in its mail header part, upon receiving data of the mail body, the user can estimate what kind of mail he/she has received, based on a ringtone corresponding to a pictogram contained in the mail body.

The stated aim can also be achieved by a mobile phone that receives mail, including: a storage unit operable to store one or more character combination patterns and sound data in correspondence with each other; a detection unit operable to detect, when the mail is received, any character combination pattern out of the one or more character combination patterns in the received mail; and an output control unit operable to output a sound based on the sound data, if the detection unit detects the character combination pattern.

According to the above structure, for example, it is possible to arbitrarily set a character combination pattern between the sender and the receiver, such as a face mark representing a facial expression and the like by combining JIS characters and symbols.

The stated aim can also be achieved by a mobile phone that receives mail, including: a storage unit operable to store one or more pieces of image data and sound data in correspondence with each other; a detection unit operable to detect, when the mail is received, any piece of image data out of the one or more pieces of image data in the received mail; and an output control unit operable to output a sound based on the sound data, if the detection unit detects the piece of image data.

According to the above structure, for example, if image data is commonly held between the sender and the receiver, sound data is stored in correspondence with such image data, as with a pictogram independently defined by a communication service provider, a JIS character, and the like. As a result, when receiving mail containing the image data, the sound data corresponding to the image data is output.

### BRIEF DESCRIPTION OF THE DRAWINGS

FIG. 1 shows a functional structure of a mobile phone 100 according to an embodiment of the present invention.

FIG. 2 shows an example of a pictogram data table and a sound data table stored in the mobile phone 100 according to the embodiment of the present invention beforehand.

FIG. 3 shows an example of a ringtone setting information table and an operation setting information stored in the mobile phone 100 according to the embodiment of the present invention.

FIG. 4 shows an example of changes in screen for setting a ringtone of the mobile phone 100 according to the embodiment of the present invention, and an example of display of received mail.

FIG. 5 is a flowchart of an operation of the mobile phone 100 according to the embodiment of the present invention.

FIG. 6 shows an appearance of the mobile phone 100 according to the embodiment of the present invention.

### DESCRIPTION OF REFERENCE NUMERALS

100 . . . mobile phone
110 . . . display unit
120 . . . input unit
130 . . . antenna
140 . . . radio unit
150 . . . control unit
151 . . . setting unit
152 . . . display control unit
153 . . . pictogram detection unit
154 . . . ringtone determination unit
160 . . . storage unit
170 . . . speaker driving unit
180 . . . speaker

### BEST MODE FOR CARRYING OUT THE INVENTION

### First Embodiment

The following describes an overview of a mobile phone according to a first embodiment of the present invention.

### <Overview>

The mobile phone according to this embodiment receives mail from a server of a mobile communication service provider via an antenna. If a pictogram predetermined by the mobile communication service provider is contained in the mail, the mobile phone outputs a ringtone corresponding to that pictogram to inform the user, upon receiving the mail.

A pictogram is an image relating to font data that is shown by a character code (hereafter referred to as a “pictogram code”) predetermined according to specifications of each individual mobile communication service provider. It is assumed here that the mobile phone holds font data corresponding to each pictogram code beforehand. Also, it is assumed here that the mail received by the mobile phone is sent from a mobile phone of the same mobile communication service provider.

### <Appearance>

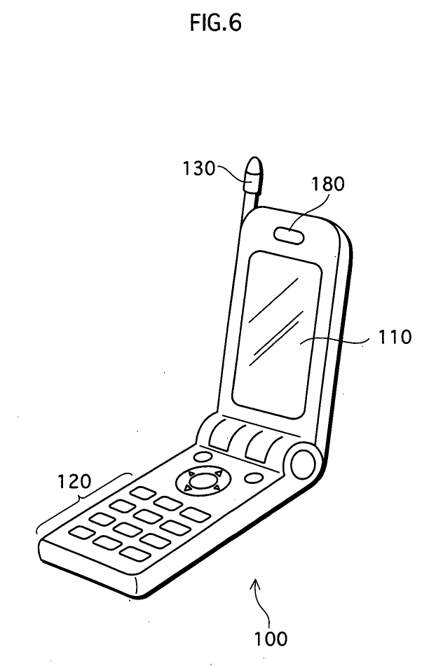

FIG. 6 shows an appearance of the mobile phone according to this embodiment. A mobile phone 100 includes a display 110, an operation button unit 120, an antenna 130, and a speaker 180.

The mobile phone 100 receives mail that contains a pictogram code via the antenna 130, and outputs a ringtone corresponding to the pictogram code from the speaker 180.

The display 110 displays received mail and, for example, an image relating to a standby screen and the like, based on settings of each function in the mobile phone 100. The operation button unit 120 includes a numeric keypad, direction keys, and the like, and is pressed by the user when performing a function switching operation, a character input operation, and the like.

### <Structure>

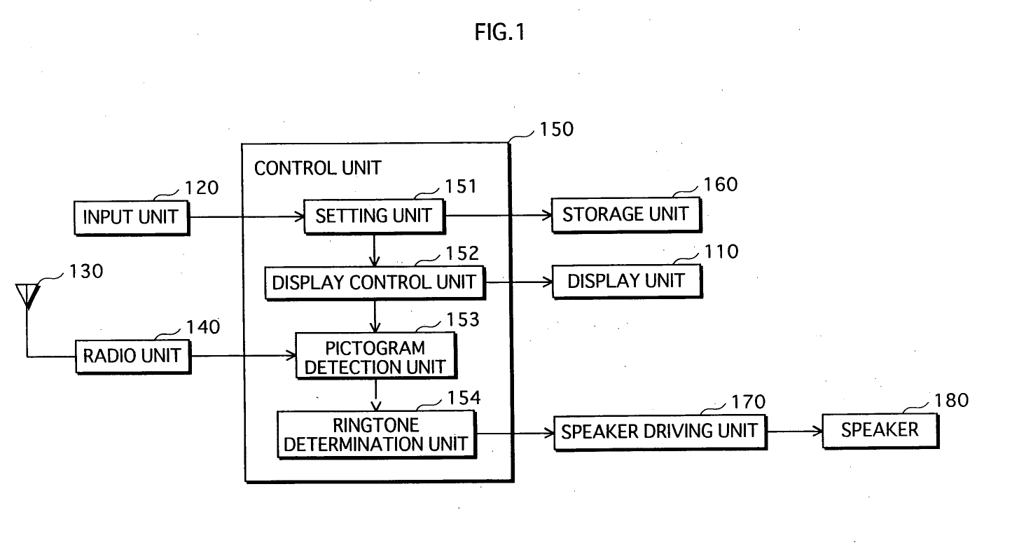

FIG. 1 shows a functional structure of the mobile phone 100 according to this embodiment.

The following describes the functional structure of the mobile phone 100 in detail, with reference to FIG. 1.

The mobile phone 100 includes a display unit 110, an input unit 120, an antenna 130, a radio unit 140, a control unit 150, a storage unit 160, a speaker driving unit 170, and a speaker 180.

The display unit 110 is composed of a liquid crystal display and the like, and displays an image such as an image relating to received mail.

The input unit 120 is composed of operation buttons including a numeric keypad, direction keys, and the like, and has a function of outputting an input signal corresponding to a button pressed by a user operation to the control unit 150.

The antenna 130 has a function of communicating with a base station of the communication service provider of the mobile phone 100.

The radio unit 140 has a function of performing radio communication with the base station via the antenna 130, and receiving a radio signal of mail data and the like from the server of the communication service provider.

The control unit 150 includes a CPU and a memory (ROM, RAM), and has a function of controlling each unit of the mobile phone 100.

The control unit 150 is roughly made up of a setting unit 151, a display control unit 152, a pictogram detection unit 153, and a ringtone determination unit 154.

The following describes each of these units.

The setting unit 151 has a function of receiving, from the user via the input unit 120, an operation of associating a keyword for sorting pictogram codes stored in the memory or the like beforehand, with sound data stored in the memory or the like, and storing the received information about the keyword and the sound data (hereafter referred to as “ringtone setting information”) into the storage unit 160 described later.

The setting unit 151 also has a function of receiving, from the user, an operation setting such as outputting a ringtone corresponding to a pictogram or outputting a ringtone corresponding to a sender upon mail reception, and storing the received setting information into the storage unit 160.

The display control unit 152 has a function of controlling the display unit 110 to display an image. For example, to display an image corresponding to a pictogram code, the display control unit 152 reads font data stored in the memory or the like beforehand in correspondence with the pictogram code, and has the display unit 110 display an image relating to the font data.

The pictogram detection unit 153 has a function of, when a radio signal received by the radio unit 140 relates to mail, demodulating the radio signal to a data signal and detecting a pictogram code based on the demodulated data and pictogram codes stored in the memory or the like.

The ringtone determination unit 154 has a function of determining sound data corresponding to a pictogram code detected by the pictogram detection unit 153, based on ringtone setting information stored in the storage unit 160.

The storage unit 160 is realized by a recording medium such as a hard disk, and stores data including various setting information such as ringtone setting information received from the setting unit 151.

The speaker driving unit 170 has a function of driving the speaker 180 according to an instruction from the ringtone determination unit 154, and controlling the speaker to output sound data determined by the ringtone determination unit 154.

The speaker 180 has a function of outputting sound data at a predetermined volume level for a certain period of time, according to an instruction from the speaker driving unit 170.

### <Data>

The following describes table data stored in the mobile phone 100.

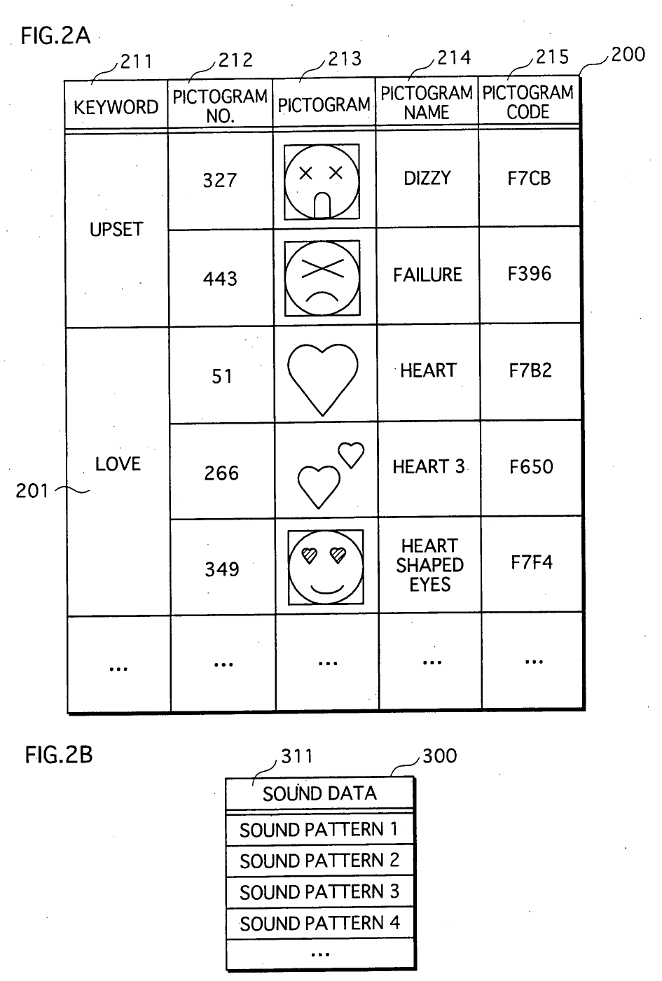

FIG. 2A shows a pictogram data table stored in the memory of the mobile phone 100 beforehand.

A pictogram data table 200 is roughly made up of a keyword 211, a pictogram No. 212, a pictogram 213, a pictogram name 214, and a pictogram code 215.

The keyword 211 shows a keyword for grouping pictograms. As one example, the keyword 211 “LOVE” 201 in the table includes pictogram Nos. “51”, “266”, and “349”.

The pictogram No. 212 is an identification number of font data relating to each pictogram in the mobile phone 100.

The pictogram 213 shows an image of the font data relating to the pictogram. The pictogram name 214 shows a name of the image relating to the font data.

The pictogram code 215 shows a character code for the pictogram, which has been determined according to specifications of the communication service provider of the mobile phone 100.

The pictogram data table 200 is read by the control unit 150 when, for example, the user sets a ringtone corresponding to a pictogram.

FIG. 2B shows a sound data table stored in the memory of the mobile phone 100 beforehand.

A sound data table 300 is roughly made up of sound data 311. The sound data 311 shows sound data that is output, for example, when receiving an incoming call or mail.

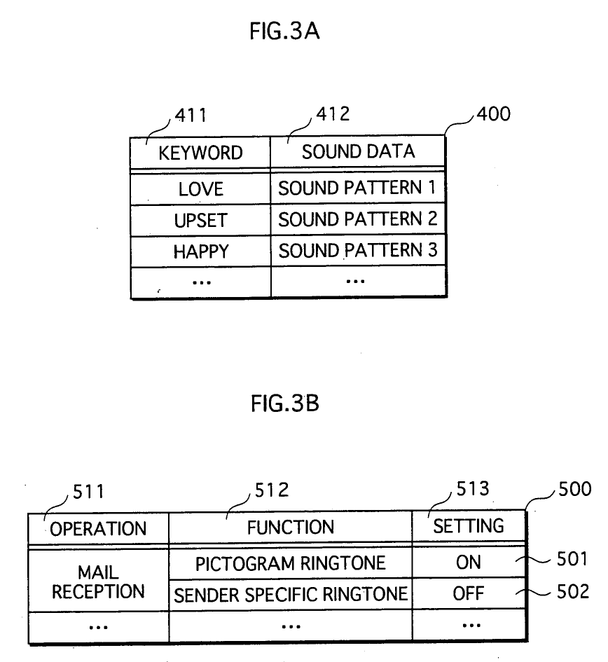

FIG. 3A shows a ringtone setting information table.

A ringtone setting information table 400 is roughly made up of a keyword 411 and sound data 412 which are associated with each other.

The keyword 411 shows a keyword to which the pictogram 213 belongs.

The sound data 412 is sound data that is output when receiving mail containing the pictogram 213.

Each set of ringtone setting information is obtained as follows. The user selects a keyword in the pictogram data table 200 and the sound data 311 in the sound data table 300 beforehand, and the setting unit 151 stores the selected keyword and sound data into the storage unit 160 in correspondence with each other.

FIG. 3B shows an operation setting information table that shows setting information (hereafter referred to as “operation setting information”) of each operation in the mobile phone 100.

In FIG. 3B, an operation setting information table 500 is roughly made up of an operation 511, a function 512, and a setting 513 which are associated with each other.

The operation 511 shows an operation in the mobile phone 100, such as mail reception and call reception.

The function 512 shows each function in the mobile phone 100 corresponding to the operation 511. For instance, functions at the time of mail reception include a function of outputting a ringtone (hereafter referred to as a “pictogram ringtone”) corresponding to a pictogram if the pictogram is contained in the mail, and a function of outputting a ringtone (hereafter referred to as a “sender specific ringtone”) specific to a sender of the mail.

The setting 513 shows a setting state of each function included in the function 512. For example, the “pictogram ringtone” in the function 512 is set to ON in a row 501 of the table, and the “sender specific ringtone” in the function 512 is set to OFF in a row 502 of the table. In this case, when the mobile phone 100 receives mail, the mobile phone 100 outputs a pictogram ringtone if the mail contains a pictogram.

### <Operation>

The following describes an operation of the mobile phone 100 according to the present invention.

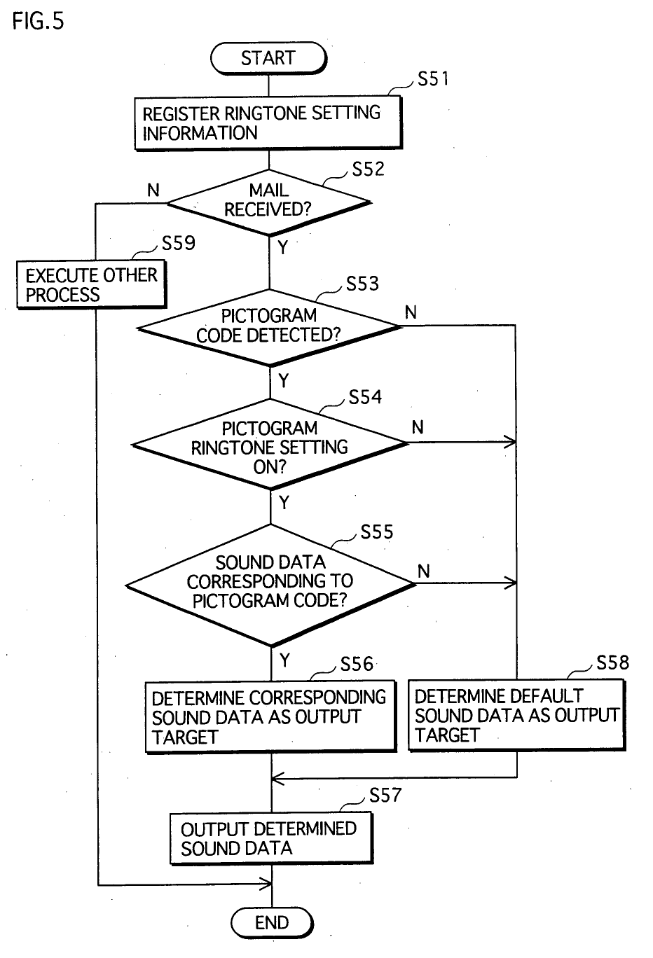

FIG. 5 is a flowchart of an operation of the mobile phone 100.

The mobile phone 100 receives an input of ringtone setting information from the user and registers the received ringtone setting information. When receiving mail, the mobile phone 100 determines sound data based on the registered ringtone setting information, and outputs the determined sound data.

Here, it is assumed that the “pictogram ringtone” is set to ON and the “sender specific ringtone” is set to OFF in the operation setting information table 500.

In step S51, the setting unit 151 has the display unit 110 display an image for receiving an input of ringtone setting information in accordance with an operation of the input unit 120 by the user. The setting unit 151 receives an input of ringtone setting information from the user via the input unit 120, and stores the received ringtone setting information into the storage unit 160.

In step S52, when the radio unit 140 receives mail via the antenna 130 (step S52: Y), the radio unit 140 outputs a radio signal showing the received mail data to the pictogram detection unit 153.

When the radio unit 140 does not receive mail in step S52 (step S52: N), a process relating to another operation is executed (step S59).

Following step S52, upon receiving the mail data relating to the radio signal from the radio unit 140, the pictogram detection unit 153 reads the pictogram code 215 in the pictogram datatable 200, and detects whether or not data of the pictogram code 215 is contained in the mail data (step S53).

If the pictogram detection unit 153 detects the data of the pictogram code 215 in step S53 (step S53: Y), the pictogram detection unit 153 outputs data (hereafter referred to as “code data”) indicating the code, to the ringtone determination unit 154.

Upon receiving the code data from the pictogram detection unit 153, the ringtone determination unit 154 reads the operation setting information table 500, and judges whether or not the pictogram ringtone setting is ON (step S54).

If the ringtone determination unit 154 judges that the pictogram ringtone setting is ON in step S54 (step S54: Y), the ringtone determination unit 154 reads the pictogram data table 200, and stores data showing a keyword corresponding to the received code data into the memory. Also, the ringtone determination unit 154 reads the ringtone setting information table 400, and judges whether or not sound data corresponding to the keyword stored in the memory is included in the ringtone setting information table 400 (step S55).

If the ringtone determination unit 154 judges that there is the sound data corresponding to the keyword in step S55 (step S55: Y), the ringtone determination unit 154 determines the sound data as an output target (step S56).

Following this, the ringtone determination unit 154 outputs a signal to output the determined sound data, to the speaker driving unit 170. The speaker driving unit 170 activates the speaker 180, reads the instructed sound data from the memory, and has the speaker 180 output the sound data (step S57).

If the pictogram detection unit 153 does not detect the data of the pictogram code 215 in step S53, the pictogram detection unit 153 outputs a signal indicating that no data of the pictogram code 215 is detected, to the ringtone determination unit 154 (step S53: N). The ringtone determination unit 154 determines default sound data as an output target, and instructs the speaker driving unit 170 to output the default sound data (step S58).

Also, if the ringtone determination unit 154 judges that the pictogram ringtone setting is not ON in step S54 (step S54: N) or if the ringtone determination unit 154 judges that there is no sound data corresponding to the pictogram code detected by the pictogram detection unit 153 in step S55 (step S55: N), step S58 is performed.

### <Operation Example>

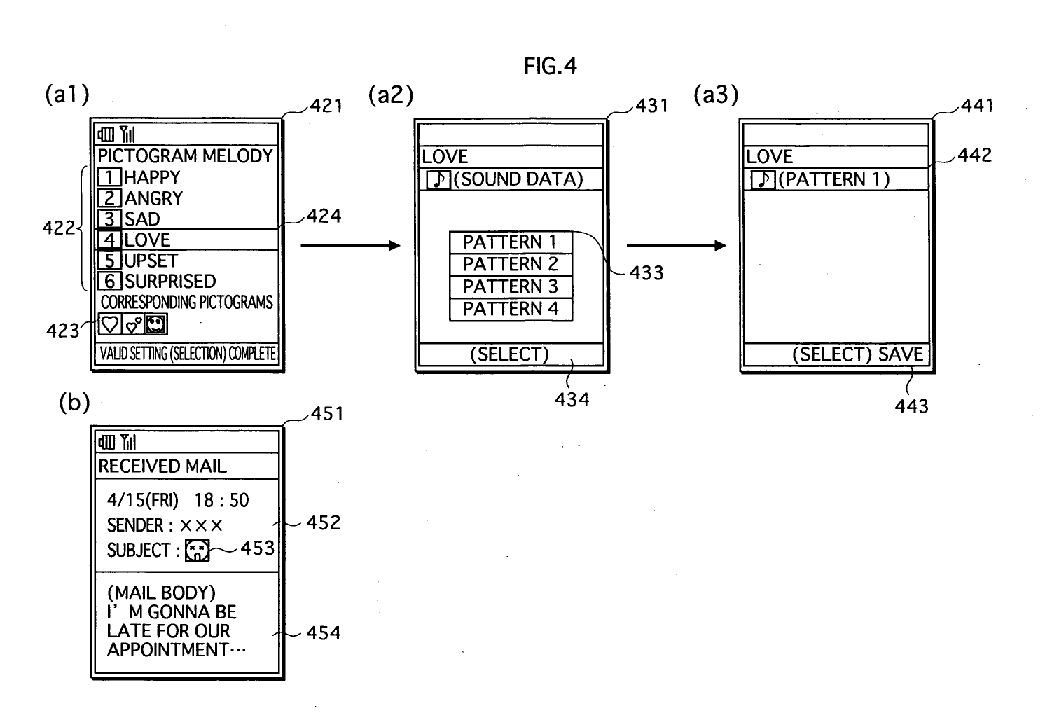

The following describes an operation when the mobile phone 100 receives mail shown in FIG. 4(b), based on the above operation flow (FIG. 5).

The mail (a screen 451) shown in FIG. 4(b) contains a pictogram 453 in a subject part of a mail header 452. The pictogram 453 has a code “F7CB” that belongs to the keyword “UPSET” in the pictogram data table 200.

In the operation example of this embodiment, the mail received by the mobile phone 100 is composed of data of the mail header 452 that includes a mail reception date and time, a sender, and a subject, and data of a mail body 454. The mobile phone 100 receives the data of the mail header 452. If pictogram data is contained in the subject part of the mail header 452, the mobile phone 100 determines sound data corresponding to the pictogram data. The mobile phone 100 outputs the determined sound data upon receiving the data of the mail header 452.

FIGS. 4(a1) to 4(a3) show changes in screen when having the display unit 110 display an image for receiving a ringtone setting information input operation by a user operation and receiving an input of ringtone setting information in step S51.

FIG. 4(a1) shows a ringtone setting information input screen 421. Upon receiving an instruction to display the input screen 421 from the user, the setting unit 151 has the display unit 110 display an image constituting this screen.

In FIG. 4(a1), reference numeral 422 denotes a list of keywords included in the keyword 211 in the pictogram data table 200, where a row 424 of the keyword “LOVE” is currently selected by a user operation. Reference numeral 423 denotes a list of pictograms corresponding to the keyword “LOVE”.

FIG. 4(a2) shows a screen 431 for displaying, in a state where the keyword “LOVE” in FIG. 4(a1) is being selected, a list of names of sound data that can be associated with the keyword, in order to receive a selection of sound data from the user.

Reference numeral 433 denotes a list of names of sound data included in the sound data table 300 stored in the memory. The user selects desired sound data from “pattern 1” to “pattern 4”, by operating the direction keys and the like.

In FIG. 4(a2), when the user selects sound data of “pattern 1”, “pattern 1” is displayed as sound data corresponding to the keyword “LOVE”, as shown by reference numeral 442 in FIG. 4(a3) (a screen 441). When save 443 is selected by a user operation, the setting unit 151 stores “pattern 1” into the ringtone setting information table 400 in the storage unit 160 as the sound data for the keyword “LOVE”.

In step S52, if the radio unit 140 receives a radio signal showing the data of the mail header 452 (step S52: Y), the pictogram detection unit 153 reads the data of the pictogram code 215 in the pictogram data table 200.

After this, upon detecting the code “F7CB” in the data of the mail header 452 relating to the received radio signal (step S53: Y), the pictogram detection unit 153 outputs code data showing the code “F7CB” to the ringtone determination unit 154. The ringtone determination unit 154 reads the pictogram ringtone function setting information in the operation setting information table 500, and judges that the pictogram ringtone setting is ON (step S54: Y).

The ringtone determination unit 154 reads the pictogram data table 200, and stores data indicating the keyword “UPSET” to which the received code data belongs, into the memory. The ringtone determination unit 154 also reads the ringtone setting information table 400, and determines the sound data “sound pattern 2” corresponding to the keyword “UPSET” stored in the memory, as an output target (step S55: Y, step S56).

The ringtone determination unit 154 then outputs a signal to have the speaker 180 output the sound data of “sound pattern 2”, to the speaker driving unit 170. The speaker driving unit 170 activates the speaker 180 and has the speaker 180 output the instructed sound data (step S57).

The above operation example describes the case where only the code “F7CB” is contained in the received mail header 452. If a plurality of pictogram codes of a same keyword are contained or if a plurality of pictogram codes of different keywords are contained, sound data corresponding to a pictogram code that is detected first by the pictogram detection unit 153 is output.

### <Supplementary Remarks>

Although the mobile phone according to the present invention has been described based on the embodiment, it should be obvious that the present invention is not limited to the above embodiment. For example, the following modifications are possible.

(1) The above embodiment describes the case where, when a plurality of pictogram codes are contained in mail, sound data corresponding to a keyword to which a pictogram code detected first by the pictogram detection unit 153 belongs is determined as an output target. As an alternative, for all pictogram codes detected by the pictogram detection unit 153, sound data respectively corresponding to keywords to which these pictogram codes belong may be output in an order in which the pictogram codes are detected.

(2) The above embodiment describes the case where, when a plurality of pictogram codes are contained in a mail header, sound data corresponding to a keyword to which a pictogram code detected first by the pictogram detection unit 153 belongs is determined as an output target. As an alternative, sound data corresponding to a keyword to which a largest number of pictogram codes detected by the pictogram detection unit 153 belong may be determined as an output target. Also, sound data respectively corresponding to keywords to which the pictogram codes detected by the pictogram detection unit 153 belong may be output in a descending order of the number of pictogram codes that belong.

(3) The above embodiment describes the case where pictogram codes are sorted by predetermined keywords and sound data is stored in correspondence with each keyword. However, sound data may be stored in correspondence with each pictogram code. In this case, when the pictogram detection unit 153 detects a plurality of pictogram codes, sound data corresponding to a pictogram code that is detected a largest number of times may be determined to be output. Also, sound data respectively corresponding to the pictogram codes detected by the pictogram detection unit 153 may be output in a descending order of the number of occurrences, as in the above (2).

(4) The above embodiment describes the case where, when receiving data of a mail header, sound data corresponding to a keyword to which a pictogram code contained in the mail header belongs is output. When receiving data of a mail body following the data of the mail header, the pictogram detection unit 153 may further detect a pictogram code in the data of the mail body so that the ringtone determination unit 154 outputs a ringtone corresponding to the pictogram code upon receiving the data of the mail body.

(5) The above embodiment describes the case where mail is composed of data of a mail header and data of a mail body, but the mail may instead be short mail with no mail header, as one example. In the case of short mail, upon receiving a mail body, sound data corresponding to a keyword to which a pictogram code contained in the data of the mail body belongs is determined to be output.

(6) The above embodiment describes the case where sound data is output for the certain period of time at the time of mail reception. As an alternative, the setting unit 151 may receive an input of a time period for outputting individual sound data from the user. Also, an output time period may be changed depending on keyword or pictogram code. For instance, if a pictogram code belonging to a keyword “HAPPY” and a pictogram code belonging to a keyword “ANGRY” are contained in received mail, sound data corresponding to the pictogram code of the keyword “ANGRY” may be output shorter than sound data corresponding to the pictogram code of the keyword “HAPPY”.

(7) The above embodiment describes the case where mail contains a pictogram code, but the present invention is equally applicable to the case where mail contains a character pattern formed by a combination of letters, symbols, special characters, and the like defined by JIS, e.g. a face mark such as “m(_)m” indicating bowing.

In this case, combination patterns of character codes are stored in the memory or the like beforehand, and sound data is stored in correspondence with each of these patterns according to a user operation.

(8) The above embodiment describes the case where mail contains apictogramcode, but the present invention is equally applicable to the case where, for example, mail contains image data, such as a photograph or a picture, that is held commonly in mobile phones of both a mail sender and a mail receiver. In this case, in the same way as the above embodiment, image data and sound data are stored in correspondence with each other beforehand so that, upon receiving mail, a detection unit detects predetermined image data in data of the mail and outputs sound data corresponding to the image data.

(9) The above embodiment describes the case where sound data determined by the ringtone determination unit 154 is output at the predetermined volume level. Alternatively, a volume level of sound data may be determined depending on keyword or pictogram code so that the sound data is output at the determined volume level. As one example, sound data corresponding to the keyword “UPSET” may be output at a higher volume level than sound data corresponding to other keywords.

(10) Also, if received mail contains a same pictogram code a plurality of times, sound data corresponding to that pictogram code may be repeatedly output with a fixed time interval, in accordance with the number of occurrences of the pictogram code.

(11) Also, if received mail contains a plurality of pictogram codes, a volume level may be determined according to the number of pictogram codes belonging to a same keyword or the number of occurrences of a same pictogram code, so that sound data is output at a corresponding volume level.

(12) Also, a set of characters formed by the user arbitrarily combining character codes showing JIS letters, symbols, special characters, pictograms, and the like so as to enable the sender and the receiver to recognize a common meaning, may be stored in correspondence with sound data indicating that meaning.

Also, a pattern that repeats characters, pictograms, and the like combined in the above manner with a fixed interval may be stored in correspondence with sound data, so that the sender and the receiver can recognize a common meaning. Furthermore, the pattern may be stored in correspondence with a volume level of the sound data.

According to this structure, a character, a repetition pattern, and the like that is common to the sender and the receiver can be contained in mail. When such mail is received, a ringtone can be output without causing a third party to estimate the contents of the mail.

(13) The above embodiment describes the case where a pictogram ringtone is output if the mail reception operation setting is such that the sender specific ringtone setting is OFF and the pictogram ringtone setting is ON. However, the present invention is equally applicable to the case where both the sender specific ringtone setting and the pictogram ringtone setting are ON.

As one example, in the case where both of the above settings are ON, the setting unit 151 receives an operation of selecting sound data specific to a sender from the user, and stores information about the sender and the sound data in the storage unit 160. When receiving mail containing a pictogram, the ringtone determination unit 154 has the speaker output sound data corresponding to a sender of the mail, and then output sound data corresponding to the pictogram detected by the pictogram detection unit 153.

(14) A program for having a processor execute an output control process of sound data corresponding to a character, such as a pictogram, at the time of mail reception may be distributed having been recorded on a recording medium or via a communication path and the like. Examples of such a recording medium include an IC card, a hard disk, an optical disc, a flexible disk, a ROM, and the like. The distributed program is stored in a memory or the like that is readable by the processor, and submitted to use. The functions of the mobile phone described in the above embodiment can be realized by the processor executing this program.

### INDUSTRIAL APPLICABILITY

The present invention can be used for a, mobile phone that is capable of receiving mail containing a pictogram and the like and, upon receiving the mail, informing of the reception by a ringtone.

1. A mobile phone that receives mail, comprising:
a storage unit operable to store one or more specific characters and sound data in correspondence with each other;
a detection unit operable to detect, when the mail is received, any specific character out of the one or more specific characters in the received mail; and
an output control unit operable to output a sound based on the sound data, if the detection unit detects the specific character.

2. The mobile phone of claim 1,
wherein the mail contains one or more types of specific characters,
the storage unit stores sound data corresponding to each type of specific character,
the detection unit detects the one or more types of specific characters from a beginning of the mail in sequence, and
the output control unit determines, as an output target, sound data corresponding to a type of specific character detected first by the detection unit, and outputs the sound based on the sound data determined as the output target.

3. The mobile phone of claim 1,
wherein the one or more specific characters are a plurality of types of specific characters,
the detection unit detects the plurality of types of specific characters in the mail and, for each type of specific character, counts a number of times the type of specific character is detected, and
the output control unit determines, as an output target, sound data corresponding to a type of specific character having a largest number of times counted by the detection unit, and outputs the sound based on the sound data determined as the output target.

4. The mobile phone of claim 1,
wherein the mail contains one or more types of specific characters,
the storage unit stores sound data corresponding to each type of specific character,
the detection unit detects the one or more types of specific characters from a beginning of the mail in sequence, and
the output control unit determines, as an output target, sound data corresponding to each type of specific character detected by the detection unit, and outputs the sound based on the sound data determined as the output target in an order of the detection by the detection unit.

5. The mobile phone of claim 1,
wherein the one or more specific characters are a plurality of types of specific characters,
the storage unit stores a plurality of groups into which the plurality of types of specific characters are sorted, and sound data corresponding to each of the plurality of groups, and
the output control unit determines, as an output target, sound data corresponding to a group to which the specific character detected by the detection unit belongs, and outputs the sound based on the sound data determined as the output target.

6. The mobile phone of claim 1, further comprising:
a display unit operable to display the specific character; and
a selection receiving unit operable to receive a selection of the sound data while the specific character is being displayed by the display unit,
wherein the storage unit stores the displayed specific character and the selected sound data in correspondence with each other.

7. The mobile phone of claim 1,
wherein the storage unit further stores an output time period in correspondence with the sound data, and
the output control unit outputs the sound based on the sound data for the output time period corresponding to the sound data, based on the sound data and the output time period stored in the storage unit.

8. The mobile phone of claim 1,
wherein the mail is composed of mail header data and mail body data,
the detection unit detects the specific character in the mail header data, when the mail header data is received, and
the output control unit determines, when the mail header data is received, the sound data corresponding to the detected specific character as an output target, and outputs the sound based on the sound data determined as the output target.

9. The mobile phone of claim 8,
wherein the detection unit further detects the specific character in the mail body data, when the mail body data is received, and
the output control unit further determines, when the mail body data is received, the sound data corresponding to the detected specific character as an output target, and outputs the sound based on the sound data determined as the output target.

10. A mobile phone that receives mail, comprising:
a storage unit operable to store one or more character combination patterns and sound data in correspondence with each other;
a detection unit operable to detect, when the mail is received, any character combination pattern out of the one or more character combination patterns in the received mail; and
an output control unit operable to output a sound based on the sound data, if the detection unit detects the character combination pattern.

11. A mobile phone that receives mail, comprising:
a storage unit operable to store one or more pieces of image data and sound data in correspondence with each other;
a detection unit operable to detect, when the mail is received, any piece of image data out of the one or more pieces of image data in the received mail; and
an output control unit operable to output a sound based on the sound data, if the detection unit detects the piece of image data.

12. A control program for causing a program executable device to execute a process of controlling an output of a sound corresponding to a specific character, comprising:
a storage step of storing one or more specific characters and sound data in correspondence with each other;
a detection step of detecting, when mail is received, any specific character out of the one or more specific characters in the received mail; and
an output control step of outputting a sound based on the sound data, if the detection step detects the specific character.
